(19) United States
(12) Patent Application Publication
(10) Pub. No.: US 2002/0149218 A1
(43) Pub. Date: Oct. 17, 2002

(54) Transporting device for large heavy fabrics

(76) Inventor: Franz Gartner, Oberelsbach (DE)

Correspondence Address: DKW LAW GROUP, P.C., 58TH FLOOR - USX TOWER, 600 GRANT STREET, PITTSBURGH, PA, 15219, US

(21) Appl. No.: 10/013,853

(22) Filed: Dec. 10, 2001

(30) Foreign Application Priority Data
Dec. 11, 2000 (DE) 100 61 581.3

(51) Int. Cl. A47H 3/00; B66C 1/48

(52) U.S. Cl. 294/102.1; 160/382

(57) ABSTRACT

Transporting device for large heavy fabrics, having an elongated hollow rail or an elongated hollow section with an axial, slot-like insertion opening, which extends over the entire length, and a hook element which is arranged approximately in the longitudinal center of the hollow section and opposite the opening, and a clamping roller which is arranged in the interior of the hollow profile, the clamping roller being of a substantially elongated, cylindrical design, and an actuating device in order to move the clamping roller away from the opening in the hollow section.

### RELATED APPLICATION

This application claims the benefit of German Application No. 100 61 581.3 filed Dec. 11, 2000.

### FIELD OF THE INVENTION

The invention relates to a transporting device for heavy fabrics, in particular, large heavy fabrics.

### BACKGROUND OF THE INVENTION

In rooms which are used commercially, in particular office rooms, lobbies, staircases and the like, it is becoming ever more common to lay carpets, rugs, etc. which, in particular, are hired. Such carpets and other heavy fabrics have to be cleaned from time to time. When cleaning or processing these carpets or other heavy fabrics in laundromats, it is disadvantageous that these carpets can be very difficult to process because of their considerable weight and their size. In particular, hanging up and sorting them after they have been cleaned constitutes a considerable problem.

Furthermore, it is customary with hired carpets for these hired carpets to have an identification chip on the underside, in which case it should then be possible to pick out the appropriately identified carpets from an assortment in order to be able to return them.

The object of the invention is to specify a transporting device for large, heavy objects which makes possible simplified, in particular automated, picking up, suspended transportation and sorting of the heavy fabrics.

The object is achieved by the features of claim 1.

Advantageous developments are defined in the subclaims.

### SUMMARY OF THE INVENTION

According to the invention, the transporting device for large heavy fabrics has an elongated hollow section, an elongated clamping roller being mounted in the hollow section. The hollow section and the clamping roller are dimensioned in such a manner that an inserted carpet is mounted in a manner such that it is clamped in place between a wall section of the hollow section and the clamping roller while the clamping roller is supported on an opposite wall section of the hollow section, the diameter of the hollow section preferably being reduced to the insertion slot in such a manner that when the carpet is tensioned, in particular, by its own weight, the clamping action is increased. The hollow section can therefore be shaped such that it is round, trapezoidal, oval or the like in cross section; the hollow section preferably has an approximately triangular cross section. A hollow section having a triangular cross section has a flat section base and an open corner or edge opposite the base. Arranged approximately in the transverse and longitudinal center of the base is a hook which is in the form of a coat hook but is configured such that it is dimensioned with regard to the corresponding loading in terms of weight.

Situated in the interior of the hollow rail is the elongated roller which is in the manner of a cylinder and by means of which a heavy fabric which is inserted through the open edge into the hollow rail is firmly clamped in place. In order to obtain a defined position of the roller and also in order to be able to cancel the clamping action at any time manually or automatically, the roller has, in its end regions, bolts which extend through the base, a respective helical spring being arranged around the bolts between the roller and the base of the hollow rail, said helical spring acting upon the roller with a force toward the open edge of the hollow section. Outside the hollow rail, the bolts have a spherical or similar end for the purpose of actuating the roller. If a carpet or a similar heavy fabric is pushed through the open edge into the hollow rail—this may, in particular, take place in an automated manner at the end of a conveyor belt—the roller is first of all pressed inward and a longitudinal edge of the carpet enters into the rail. The rail can subsequently be picked up at the hook, in which case the tension on the hook causes the roller to be moved, assisted by the force of the springs, along a sloping side wall of the hollow section or of the hollow rail toward the open edge of the rail and in the process causing it to press the carpet against the opposite side wall of the hollow rail and to hold it together with the latter. With the hook element being similar to a coat hook, the hollow rail can then be moved and sorted like a normal coat hanger in already existing and customary sorting systems for items of clothing. The length of the section and of the roller is selected in such a manner that the clamping forces per surface area are as low as possible, in particular, is 20-150 cm long, so that no lasting impression remains on the fabric.

With the invention, it is advantageous that large heavy fabrics can be processed and sorted in a laundromat in a simple, favorable and rapid manner and, in particular, in an automated manner. It is furthermore advantageous that existing systems can be used, since the hook element makes processing as for conventional coat hangers possible.

It is furthermore advantageous that the suspended connection between the carpet and transporting device can easily be released again—in particular also in an automated manner—by pulling on the stud bolt elements.

### BRIEF DESCRIPTION OF THE DRAWINGS

The invention is explained by way of example with reference to the drawings, in which:

FIG. 1 shows a transporting device according to the invention in a section in the region of an actuating device; and

FIG. 2 shows the transporting device according to the invention in a perspective, partially sectioned plan view.

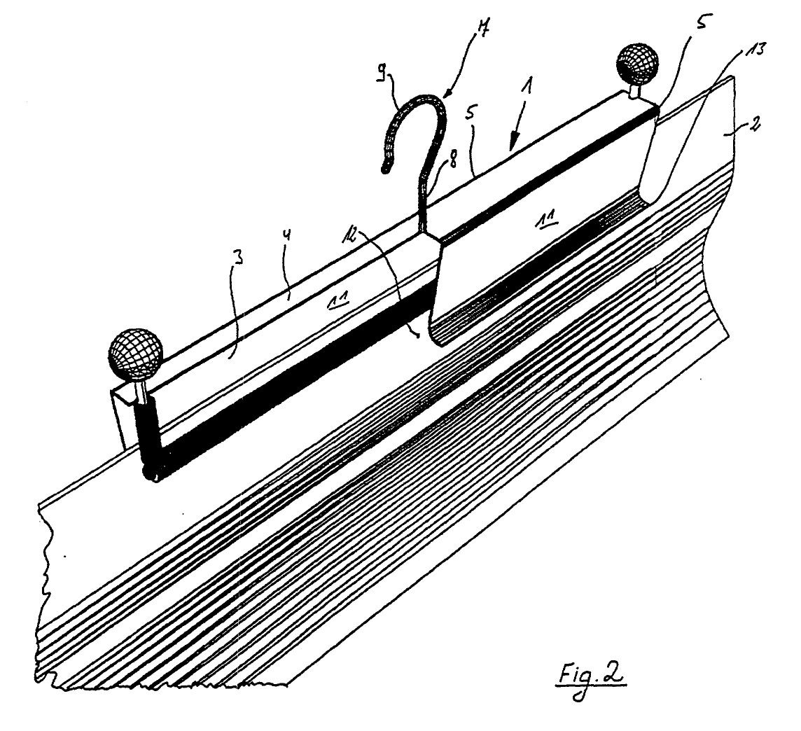

### DETAILED DESCRIPTION OF THE PREFERRED EMBODIMENTS

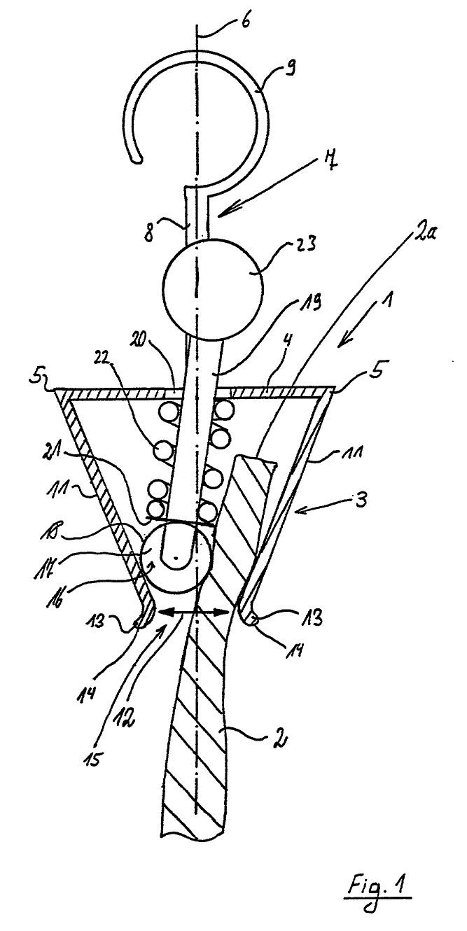

The transporting device 1 according to the invention for heavy fabrics 2, in particular large heavy fabrics 2, has a hollow rail 3 or a hollow section 3 of essentially triangular cross section. The rail 3 or the section 3 has a base or top wall 4 having longitudinally extending side edges 5. Arranged in the transverse center of a longitudinal central plane 6 (FIG. 1) is a hook element 7 which extends away from the base or top wall 4 by means of a hook shaft 8 and ends in a crook 9. The hook shaft 8 can be fastened in any desired manner to the base or top wall 4, a rotating, also rotationally mounted fastening (ball-bearings, roller bearings, etc.) being preferred in particular. The fastening is aligned and dimensioned with respect to the load to be attached.

A respective side wall 11 extends diametrically to the direction of extent of the hook element 7 from the side longitudinal edges 5 of the base or top wall 4.

The side walls 11 converge toward each other from the edges 5 until they reach a region 12 of greatest convergence from where they diverge with short lugs 13 extending outward away from one another. The lugs 13 therefore have outwardly pointing longitudinal edges 14. The lugs 13 delimit an insertion opening 15 or an insertion slot 15 of the hollow section 3.

A clamping roller 16 is arranged in the interior of the triangular hollow section 3. The clamping roller 16 is of substantially elongated, cylindrical design and therefore has opposite, circular-disk-shaped end surfaces 17 and a cylindrical casing wall 18.

Bolts 19, which can in each case be rotated, are arranged in the region of the end surfaces 17 of the clamping roller 16, the bolts extending perpendicularly to the longitudinal extent of, and in the same direction as, the clamping roller 16. The bolts 19 extend from the region of the end surfaces 17 of the clamping roller 16 through openings 20 which are arranged in the region of the ends of the triangular hollow section 3, in the base or top wall 4 thereof. In the longitudinal direction of the base or top wall 4, the openings 20 have a diameter which essentially corresponds to, or is somewhat greater than, the diameter of the bolts.

Transversely to the longitudinal extent of the base or top wall 4, the openings 20 have a diameter which is greater than the diameter of the bolts 19, in particular, is twice or three times as large. The openings can therefore, in particular, be of elongated rectangular design or of elongated rectangular design with rounded narrow side edges or of oval design. In the region of the end surfaces 17 of the clamping roller 16, the bolts 19 have a lower spring bearing 21 above the clamping roller 16, and not affecting the latter in its rotation. A helical spring 22 is arranged around the bolts between the spring bearing 21 and the base or top wall 4, said helical spring being supported at one end against the spring bearing 21 and at the other end against the base or top wall 4 and therefore presses the bolts 19, and thus also the clamping roller 16, toward the opening 15, which is defined by the lugs 13, of the triangular hollow section 3. A respective sphere 23 or another actuating element 23 for the bolts 19 and the clamping roller 16 is arranged on the end side of the bolt sections which protrude above the base or top wall 4, it being possible for said sphere or actuating element 23 to be used to pull the bolts 19, and therefore also the clamping roller 16, tight against the base or top wall 4 counter to the pressure of the spring 22.

The clamping roller 16 has a diameter which is at least dimensioned in such a manner that the diameter of the clamping roller 16 and the thickness of a carpet to be clamped in place are greater than the width of the opening 15 in the region of the greatest convergence 12 of the side walls 11. This prevents the roller 16 and/or the carpet from being able to slip out of the opening 15. The diameter of the clamping roller 16 is preferably greater than the width of the opening 15.

The surface of the cylindrical casing wall 18 may have a contoured surface in order to allow a better grip on a carpet. In particular, the surface can be provided with longitudinal grooves, outwardly protruding webs, studs or the like.

Furthermore, on the side walls 11 or the base or top wall 4 or other suitable locations, such as the hook shaft, the transporting device 1 has a coding which enables an unambiguous identification in the sorting system. This can be a bar code which, in particular, is stuck on, printed on, or stamped on by a label or is applied by similar methods. Furthermore, other write/read systems can also be used, in particular also readable chips or chips which can be read by radio can be provided on the transporting device.

Furthermore, the transporting device itself can be provided with a device for reading the identification means of a carpet, so that the transporting device makes possible, by a corresponding active or passive transmission of data, both its own identification and the identification of the attached heavy fabric.

In the following, the manner of operating the transport device according to the invention is explained.

In order to pick up a heavy fabric 2, the transporting device 1 is positioned, for example, at the end of a conveyor belt, in such a manner that the heavy fabric 2 is conveyed by a longitudinal edge 2a through the opening 15 into the triangular hollow section 3. As this happens, the clamping roller 16 is displaced counter to the pressure of the spring 22 toward the base or top wall 4. Here, the bolts 19 reach out of the base or top wall 4 by the appropriate amount. For further transportation of the heavy fabric 2, the transporting device is picked up by its hook element 7 and fitted into a transporting or sorting system or taken over by the latter. Tensioning the hook element 7 causes the heavy fabric 2 to be pulled somewhat out of the opening 15, in which case the clamping roller 16—which bears against the heavy fabric and against at least one side wall 11 because of the spring pressure—rolls along the side wall 11 bearing against it and in the process the side walls 11, which taper toward each other, cause the gap in which the heavy fabric is arranged in the triangular hollow section 3 and which is delimited by a side wall 11 on one side and the clamping roller 16 on the other side, to become narrower. By this means, the heavy fabric 2 is securely wedged in the triangular hollow section 3. The heavy fabric suspended in the hollow section 3 can then be appropriately transported and sorted.

In order to release the heavy fabric 2 from the hollow section 3 or the transporting device, tension is applied at a suitable and desired removal location, either automatically or manually, to the clamping roller 16 in the direction of the base or top wall 4, the spheres 23 causing the bolts 19 to be pulled toward the top wall 4 counter to the spring 22. This causes the gap between a side wall 11 and the clamping roller 16 to become larger until the carpet or the heavy fabric falls out of the transporting device and can be further processed.

In the invention, it is advantageous that the heavy fabric can be picked up in an easy and, in particular, automatable, and simple manner and can be transported and sorted in an existing transporting system, a simple, in particular automatable removal of the carpet or heavy fabric being possible. It is also advantageous that a coding for identifying the transporting device and/or the attached heavy fabric is possible in a simple and automatable manner.

It will be readily appreciated by those skilled in the art that modifications may be made to the invention without departing from the concepts disclosed in the foregoing description. Such modifications are to be considered as included within the scope of the appended claims unless the claims, by their language, expressly state otherwise. Accordingly, the particular embodiments described in detail hereinabove are illustrative only and are not limiting as to the scope of the invention, which is to be given the full breadth of the appended claims and any and all equivalents thereof.

I claim:

1. A transporting device for large heavy fabrics, having
a) an elongated hollow rail or an elongated hollow section having an axial, slot-like insertion opening (15) extending over the entire length, the hollow section being tapered toward the slot,
b) a hook element (7) which is arranged approximately in the longitudinal center of the hollow section (3) and opposite opening (15),
c) a clamping roller (16) which is arranged in the interior of the hollow section (3) and opposite the opening (15), and
d) an actuating device (19, 21, 22, 23) in order to move the clamping roller (16) away from the opening (15) in the hollow section (3),
the clamping roller (16) having a diameter which is at least dimensioned in such a manner that the diameter of the clamping roller and the thickness of a heavy fabric which is to be clamped in place are greater than the width of the opening (15) in the region of the greatest convergence (12) of the side walls (11) or the circumferential wall.

2. The transporting device as claimed in claim 1, wherein the rail (3) or the section (3) has a base or top wall (4) having longitudinally extending side edges, the hook element (7) being arranged in a transverse center of a longitudinal central plane (6), the said hook element extending by means of a hook shaft (8) away from the base or top wall (4) or casing wall of the hollow profile (3) and ending in a crook (9).

3. The transporting device as claimed in claim 2, wherein a respective side wall (11) extends diametrically to the direction of extent of the hook element (7) from the side longitudinal edges (5) of the base or top wall (4) of a cross-sectionally triangular hollow section, the side walls (11) converging toward one another from the edges (5) until they reach a region(12) of greatest convergence where they diverge with short lugs (13) extending outward away from one another, the lugs (13) having outwardly pointing longitudinal edges (14) and the lugs (13) delimiting the insertion opening (15) or the insertion slot (15) of the hollow section (3).

4. The transporting device as claimed in claim 3, wherein the clamping roller (16) has opposite circular-disk-shaped end surfaces (17) and a cylindrical casing wall (18), bolts (19), which can in each case be rotated, being arranged in the region of the end surfaces (17) of the clamping roller (16) and extending in the same direction perpendicularly with respect to the longitudinal extent of the clamping roller (16), the bolts (19) extending from the region of the end surfaces (17) of the clamping roller (16) through openings (20) which are arranged in the region of the ends of the hollow section (3), in the base or top wall (4) or circumferential wall thereof;
and in the longitudinal direction of the base or top wall (4), the openings (20) have a diameter which essentially corresponds to, or is somewhat greater than, the diameter of the bolts, the openings having, transversely to the longitudinal extent of the wall (4), a diameter which is larger than the diameter of the bolts (19), in particular is twice or three times as large, with the results that the opening is of elongated rectangular design or of elongated rectangular design with the rounded narrow side edges or is of oval design.

5. The transporting device as claimed in claim 4, wherein in the region of the end surfaces (17) of the clamping roller (16), and not affecting the latter in its rotation, is a lower spring bearing (21), a helical spring (22) being arranged around the bolts between the spring (21) and the base or top wall (4) or the circumferential wall of the hollow section (3), said helical spring being supported at one end against the base and the top wall (4) and therefore pressing the bolts (19), and thus also the clamping roller (16) toward the opening (15), which is defined by the lugs (13), of the hollow section (3).

6. The transporting device as claimed in claim 5, wherein a respective sphere (23) or another actuating element (23) for the bolts (19) and the roller (16) is arranged on the end side of the bolt sections protruding above the base or top wall (4), it being possible for said sphere or actuating element to be used to pull the bolts (19) tight against the base or top wall (4) or the circumferential wall counter to the pressure of the spring (22).

7. The transporting device as claimed in claim 6, wherein the clamping roller (16) has a diameter which is at least dimensioned in such a manner that the diameter of the clamping roller and the thickness of a heavy fabric which is to be clamped in place are greater than the width of the opening (15) in the region of the greatest convergence (12) of the side walls (11) or the circumferential wall.

8. The transporting device as claimed in claim 7, wherein on the side walls or the circumferential wall or the base or top wall (4) or other suitable locations, such as the hook shaft, the transporting device (1) has a coding which enables unambiguous identification in the sorting systems.

9. The transporting device as claimed in claim 8, wherein the coding is a bar code stuck on, printed on or stamped on by label, or applied by similar methods, or is another passive write/read system, in particular, is also a chip which can be read or a chip which can be read by radio.

10. The transporting device as claimed in claim 9, wherein the transporting device is provided with a device for reading an identification means of an attached heavy fabric, so that the transporting device makes possible, by an appropriate active or passive transmission of data, both its own identification and the identification of the attached heavy fabric.

11. The transporting device as claimed in claim 1, wherein the length of the section and of the roller is 20 cm to 150 cm, depending on the load.

12. Use of the device as claimed in claim 1, for sorting heavy fabrics, such as carpets or the like.

13. The transporting device as claimed in claim 1, wherein the hollow section (3) is of triangular, round, oval or trapezoidal design in cross section.

14. The transporting device as claimed in claim 2, wherein the hook shaft (8) is arranged in a rotating or rotationally mounted manner on the hollow section (3).

15. The transporting device as claimed in claim 7, wherein the diameter of the clamping roller (16) is greater than the width of the opening (15).

16. The transporting device as claimed in claim 15, wherein the surface of the cylindrical casing wall (18) of the roller (16) has a contoured surface.

17. The transporting device as claimed in claim 16, wherein the cylindrical casing wall (18) has a surface with longitudinal grooves, outwardly protruding webs, studs or the like.
